(19) United States
(12) Patent Application Publication
(10) Pub. No.: US 2023/0186623 A1
(43) Pub. Date: Jun. 15, 2023

(54) SYSTEMS AND METHODS FOR CROP DISEASE DIAGNOSIS

(71) Applicant: PING AN TECHNOLOGY (SHENZHEN) CO., LTD., Shenzhen (CN)

(72) Inventors: Ai LI, Bethesda, MD (US); Qi CHEN, Bethesda, MD (US); Ruei-Sung LIN, Bethesda, MD (US)

(73) Assignee: PING AN TECHNOLOGY (SHENZHEN) CO., LTD., Shenzhen (CN)

(21) Appl. No.: 17/551,126

(22) Filed: Dec. 14, 2021

(51) Int. Cl. G06V 20/10; A01G 13/00; G06V 10/10; G06V 10/44; G06V 10/762; G06V 10/82

(52) U.S. Cl. CPC G06V 20/188; A01G 13/00; G06V 10/17; G06V 10/443; G06V 10/762; G06V 10/82

(57) ABSTRACT

A crop disease diagnosis system is disclosed. The crop disease diagnosis system includes a communication module, a crop disease database and a crop feature classification module. The communication module is configured to receive a crop image. The crop disease database stores at least one crop disease sample case. The crop feature classification module is configured to extract a feature vector representation of the crop image, compare the feature vector representation of the crop image with the at least one crop disease sample case, and classify a crop disease associated with the crop image. The feature vector representation of the crop image is extracted by a feature extraction network, and a fully connected layer is removed from the feature extraction network during classification of the crop disease.

### TECHNICAL FIELD

The present disclosure relates to crop disease diagnosis systems and methods for diagnosing a crop disease, and more particularly, to image-based crop disease diagnosis systems and methods for diagnosing a crop disease based on crop images.

### BACKGROUND

The prevention and control of crop diseases is a very important subject for agricultural development. For preventing and controlling the crop diseases, farmers need a system and method that can quickly and easily classify or identify plant diseases. In addition, a technician or a professional may also need the crop disease diagnosis system to obtain information of crop diseases for researching and developing solutions or prevention methods.

Another possibility is that a new crop disease is discovered. At this time, a system that can quickly and correctly classify new crop diseases can greatly help agricultural development and provide information for further research.

Embodiments of the disclosure address the above needs by providing an intellectual classification system and method to classify crop diseases quickly and correctly and also providing an expandable flexibility of the system when a new crop disease is discovered.

### SUMMARY

Embodiments of the crop disease diagnosis system and the method for diagnosing a crop disease are disclosed herein.

In one aspect, a crop disease diagnosis system is disclosed. The crop disease diagnosis system includes a communication module, a crop disease database and a crop feature classification module. The communication module is configured to receive a crop image. The crop disease database stores at least one crop disease sample case. The crop feature classification module is configured to extract a feature vector representation of the crop image, compare the feature vector representation of the crop image with the at least one crop disease sample case, and classify a crop disease associated with the crop image. The feature vector representation of the crop image is extracted by a feature extraction network, and a fully connected layer is removed from the feature extraction network during classification of the crop disease.

In another aspect, a method for diagnosing a crop disease is disclosed. A crop image is received, and a feature vector representation of the crop image is retracted by a feature extraction network. The feature vector representation of the crop image is compared with at least one crop disease sample case in a crop disease database to classify the crop disease. A fully connected layer is removed from the feature extraction network during classification of the crop disease.

In still another aspect, a method for building a feature extraction network of a crop disease diagnosis system is disclosed. A plurality of sample crop images are provided, and each sample crop image is annotated with a sample crop disease. The plurality of sample crop images are analyzed to obtain an original feature extraction network. A fully connected layer is removed from the original feature extraction network to obtain the feature extraction network.

In yet another aspect, a non-transitory computer-readable medium having instructions stored thereon is disclosed. The instructions are executed by at least one processor and causes the at least one processor to perform a method for diagnosing a crop disease. A crop image is received, and a feature vector representation of the crop image is retracted by a feature extraction network. The feature vector representation of the crop image is compared with at least one crop disease sample case in a crop disease database to classify the crop disease. A fully connected layer is removed from the feature extraction network during classification of the crop disease.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated herein and form a part of the specification, illustrate implementations of the present disclosure and, together with the description, further serve to explain the present disclosure and to enable a person skilled in the pertinent art to make and use the present disclosure.

FIG. 1 illustrates an exemplary crop disease diagnosis system, according to embodiments of the disclosure.

FIG. 2 illustrates an exemplary crop disease diagnosis system, according to embodiments of the disclosure.

FIG. 3 illustrates an exemplary feature extraction network building procedure, according to embodiments of the disclosure.

FIG. 4 illustrates an exemplary crop disease classification procedure, according to embodiments of the disclosure.

FIG. 5 is a flowchart of an exemplary method for diagnosing a crop disease, according to embodiments of the disclosure.

FIG. 6 is a flowchart of an exemplary method for building a feature extraction network of a crop disease diagnosis system, according to embodiments of the disclosure.

Implementations of the present disclosure will be described with reference to the accompanying drawings.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

In recent years, the development of deep learning technology has promoted the progress and advancement of industrial production from all aspects. In the agricultural field, deep learning technology is also widely used at various stages of the crop growth cycle. In order to better monitor the health and growth status of crops, diagnosis systems and methods based on images of crops or crop leaves are needed.

However, conventional crop disease diagnosis systems or deep learning methods for diagnosing crop diseases usually rely on a large number of sample images and high-precision training data sets. In order to diagnose or classify a type of crop diseases, a large amount of annotated image data is required as an input, and then a complex calculation is performed based on these data. These operations not only increase the difficulty of data collection, but also require manpower and hardware resources to classify and annotate the collected images, which increases the cost of constructing such a diagnosis system.

Further, the results of conventional image classification models are limited to application scenarios that have already appeared in the training data. When new application scenarios emerge and result in an increase of the types of model classification and recognition, the conventional image classification model must re-collect data and re-train a brand-new model again. If the image classification model needs frequent expansion, re-training will not only be time consuming but also cause a waste of original training investment.

Embodiments of the present disclosure provides image-based crop disease diagnosis systems and methods for diagnosing a crop disease based on crop images with rapid expansion capability. The systems and methods may be applied to all types of crops (e.g., rice, corn, wheat, potato, tomato, cabbage, etc.) that have diseases observable on outside appearances. The crop disease diagnosis systems can be expanded on the basis of the original model with less training or even no additional training, and the methods of training expand the classification results of the model to a larger range of applications.

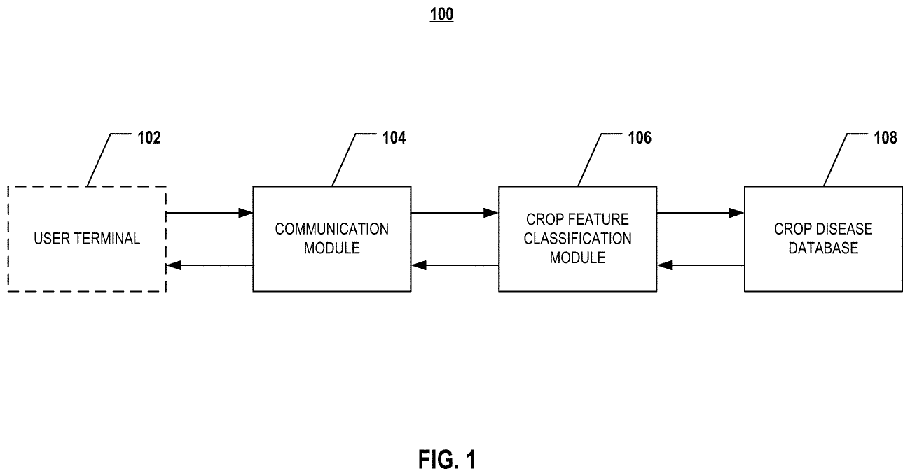

FIG. 1 illustrates a crop disease diagnosis system 100, according to embodiments of the disclosure. Crop disease diagnosis system 100 includes a user terminal 102, a communication module 104, a crop feature classification module 106 and a crop disease database 108. It is understood that user terminal 102 may or may not be part of system 100, according to the present disclosure. User terminal 102 may acquire imaging data and have two-way data transmission capability. On one hand, user terminal 102 may be used to obtain crop images and transmit the obtained crop images to communication module 104. In some embodiments, user terminal 102 may be a camera-ready cellphone or any other suitable device capable of acquiring images. User terminal 102 may be able to take motion, still, or both types of images. In some embodiments, a user may use user terminal 102 to take pictures of a crop seen on an agricultural field and transmit the pictures to communication module 104. On the other hand, user terminal 102 may receive data from other modules or components of system 100. For example, when the crop images are classified by crop disease diagnosis system 100, the classification result may be sent to user terminal 102.

Communication module 104 may be coupled to user terminal 102 and crop feature classification module 106. It may receive the crop images from user terminal 102 and transmit the crop images to crop feature classification module 106. Further, after the crop images are classified, communication module 104 may transmit the classification result to user terminal 102. Furthermore, in some embodiments, during the training procedure to build a feature extraction network of a crop disease diagnosis system, communication module 104 may be configured to receive the sample crop images and transmit the sample crop images to crop feature classification module 106, in which each sample crop image is annotated with a sample crop disease.

Crop feature classification module 106 may extract a feature vector representation of each crop image. Crop disease database 108 may store at least one crop disease sample case. The feature vector representation of each crop image is compared with crop disease sample cases stored in crop disease database 108 to classify a crop disease associated with the crop image.

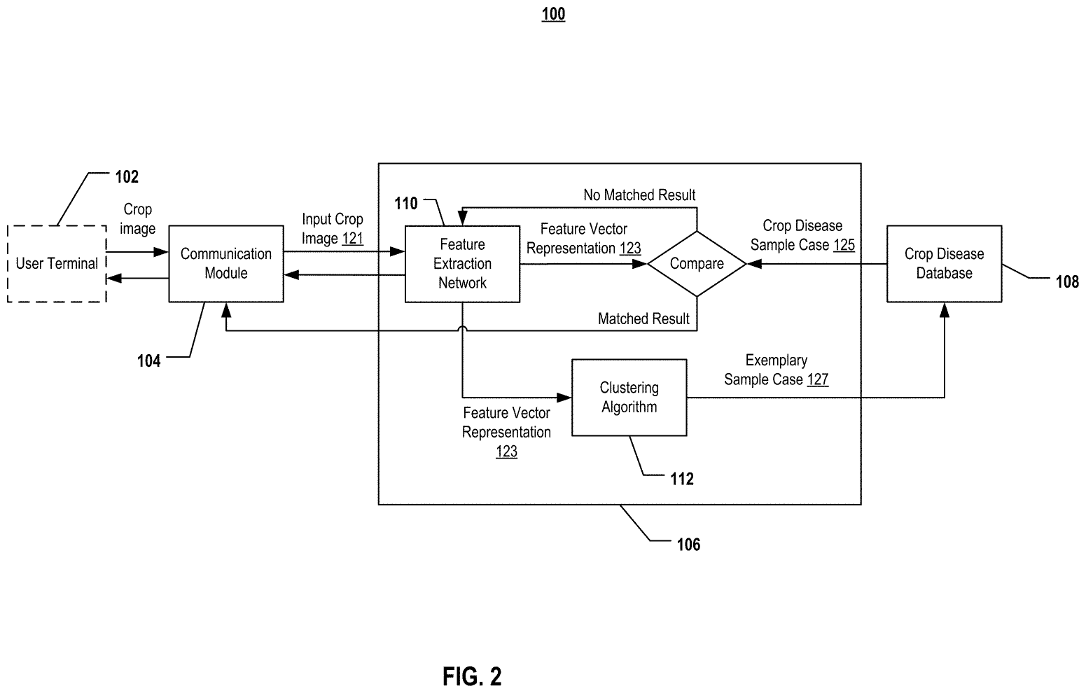

FIG. 2 illustrates crop disease diagnosis system 100 with detailed architecture, according to embodiments of the disclosure. In some embodiments, the user may use user terminal 102, e.g., a cellphone, to take a crop picture as a crop image and upload the crop image to a server having crop disease diagnosis system 100 through the network. The crop image may be processed by crop feature classification module 106 and the diagnosis result may be obtained through real-time feedback.

In some embodiments, the crop image acquired by user terminal 102 may be transmitted to communication module 104, which forwards the image as an input crop image 121 to crop feature classification module 106. Within crop creature classification module 106, input crop image 121 may be converted to a feature vector representation 123 via a feature extraction network 110. In other words, feature vector representation 123 of input crop image 121 is extracted by feature extraction network 110. Then, feature vector representation 123 of input crop image 121 may be compared with one or more crop disease sample cases 125 stored in crop disease database 108. When a matched result is found, the classification result may be transmitted to communication module 104, and communication module 104 may forward the classification result to user terminal 102.

In some embodiments, in the situation that feature vector representation 123 of input crop image 121 does not match any of crop disease sample cases 125 in crop disease database 108, crop feature classification module 106 may further update crop disease database 108. Under this situation, crop feature classification module 106 may use the unmatched crop image to update crop disease database 108 or prompt user terminal 102 to take more crop images. For example, once no matched result is found, feature vector representation 123 may be provided from feature extraction network 110 to a clustering algorithm 112 so that an exemplary sample case 127 may be obtained. Exemplary sample case 127 may be added to crop disease database 108 to expand crop disease database 108. The updated crop disease database 108 may be used to classify this new crop disease in the future.

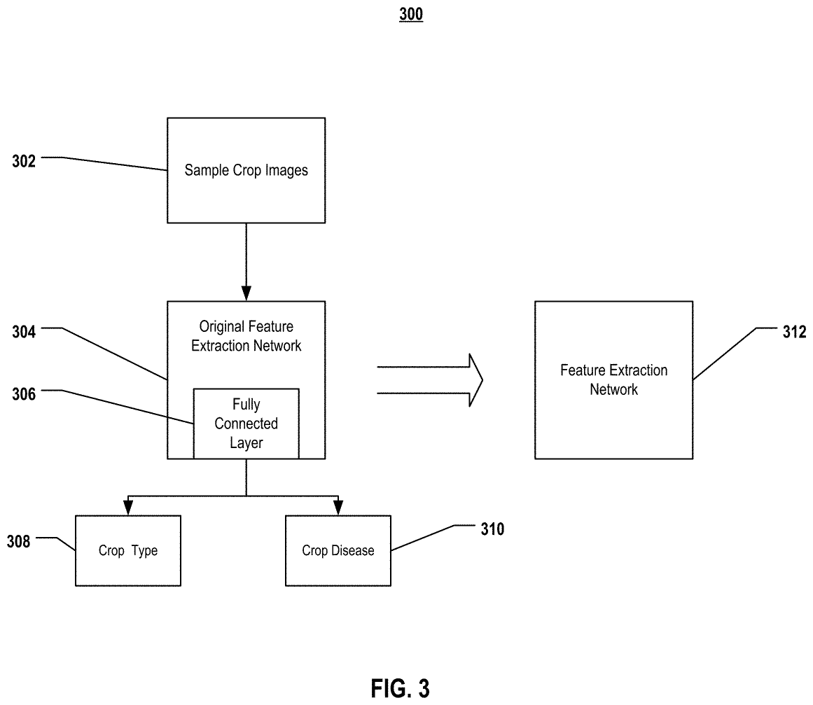

FIG. 3 illustrates a feature extraction network building procedure 300 for building feature extraction network 110 of crop disease diagnosis system 100, according to embodiments of the disclosure. In some implementations, feature extraction network 312 may be built based on a deep learning image classification model. First, a certain number of sample crop images 302 are annotated with the crop disease information in order to generate annotated image data. A supervised learning training of a convolutional neural network (CNN) is performed based on the annotated image data to obtain an original feature extraction network 304. Original feature extraction network 304 may include a fully connected layer 306. When feeding the annotated image data to original feature extraction network 304, pre-trained models of image classification may be applied. In addition, in model training, the method adopts a training strategy of multi-task learning to identify a crop type 308 and a crop disease 310 at the same time.

As shown in FIG. 3, after training original feature extraction network 304, fully connected layer 306 may be removed to obtain a feature extraction network 312. Feature extraction network 312 may convert or extract an image (e.g., a crop image) into a feature vector representation.

Feature extraction network building procedure 300 uses fully connected layer 306 to extract feature vector representations of a plurality of sample crop images 302 and obtain original feature extraction network 304. Each sample crop image 302 is associated with at least one crop disease sample case. Feature extraction network building procedure 300 also annotates each sample crop image 302 with a sample crop disease based on the feature vector representations. The feature vector representations of the plurality of sample crop images 302 indicate at least crop type 308 and crop disease 310 associated with each sample crop image 302. To extract feature vector representations, spatial information of each sample crop image 302 is first converted into original feature extraction network 302 by using fully connected layer 306. Then, fully connected layer 306 is removed from original feature extraction network 302 to obtain feature extraction network 312.

Compared with a conventional classification deep learning model, the system in the present disclosure greatly shortens the process time required for deep neural network training, improves the identification accuracy of the model, avoids over-fitting of the model, reduces the dependence of the complex model on illumination, background and other shooting environments in the image, and enhances the generalization and expansion ability of the model. In addition, the system in the present disclosure retains feature extraction network 312 by removing fully connected layer 306, makes the model lightweight, provides the possibility for model deployment to different computing platforms, and reduces the computing resources occupied by the deep learning model.

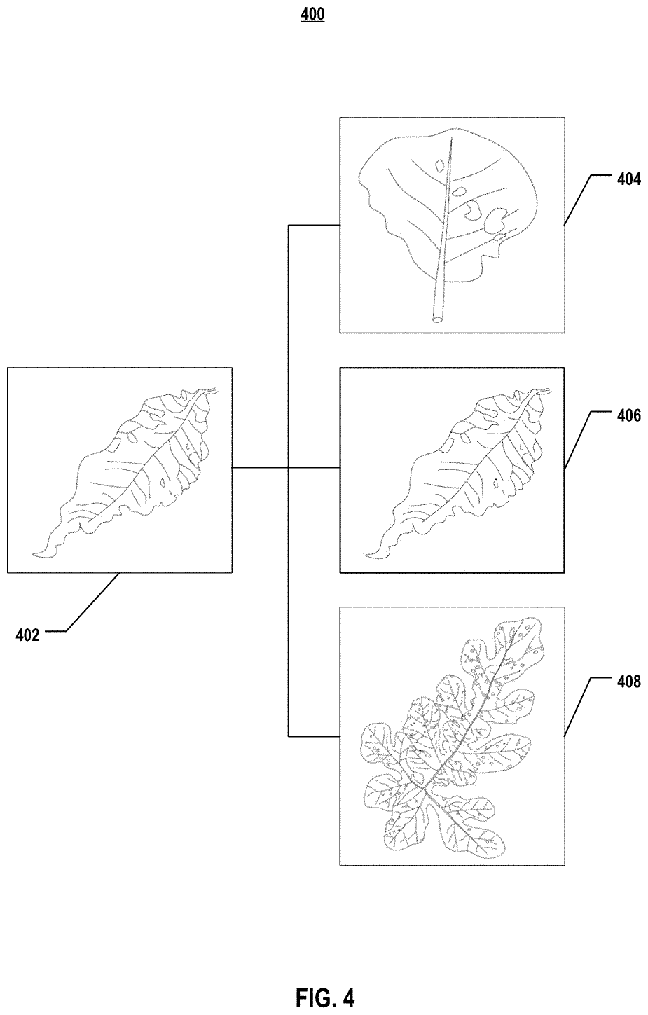

FIG. 4 illustrates a crop disease classification procedure 400, according to embodiments of the disclosure. In some implementations, the user may obtain an image 402 of crop leaves by using user terminal 102, e.g., cellphone, and image 402 is compared with sample images 404, 406 and 408. The feature vector representations of sample images 404, 406 and 408 are stored in crop disease database 108. The comparison of image 402 with images 404, 406 and 408 may first extract a feature vector representation of crop image 402 by using feature extraction network 110 to obtain feature vector representation 123 of image 402, and then comparing feature vector representation 123 of image 402 with the feature vector representations of sample images 404, 406 and 408 stored in crop disease database 108. As shown in FIG. 4, sample image 406 may have the same feature vector representation with image 402. In some embodiments, sample image 406 may have the nearest or most similar feature vector representation to image 402. The crop disease associated with sample image 406 may be returned to user terminal 102 through communication module 104, and the identification or classification result may be displayed to the user.

In some embodiments, the crop disease diagnosis system and the method for diagnosing a crop disease may use the nearest neighbor algorithm to obtain a similarity degree between two or more images. In some embodiments, the similarity degrees between the feature vector representation corresponding to the input picture, e.g., image 402, and the feature vector representations of each of the different sample cases, e.g., images 404, 406 and 408, are compared, so that the crop type, the crop disease, or both are identified or classified based on the similarity degree of the feature vector representation. For example, the sample case with the highest similarity degree of the feature vector representation may be selected to classify the new case illustrated in the input picture. Because the feature extraction network 110 is a lightweight model with the removal of the fully connected layer, the process time would be shortened, and the process loading would be reduced.

In contrast to conventional classification models, special and extreme cases may be better handled based on using the similarity degree of known samples in the present disclosure. Moreover, by adopting a multi-sample comparison mode, the training difficulty of the model in the present disclosure can be reduced, and the final accuracy of the model can be improved.

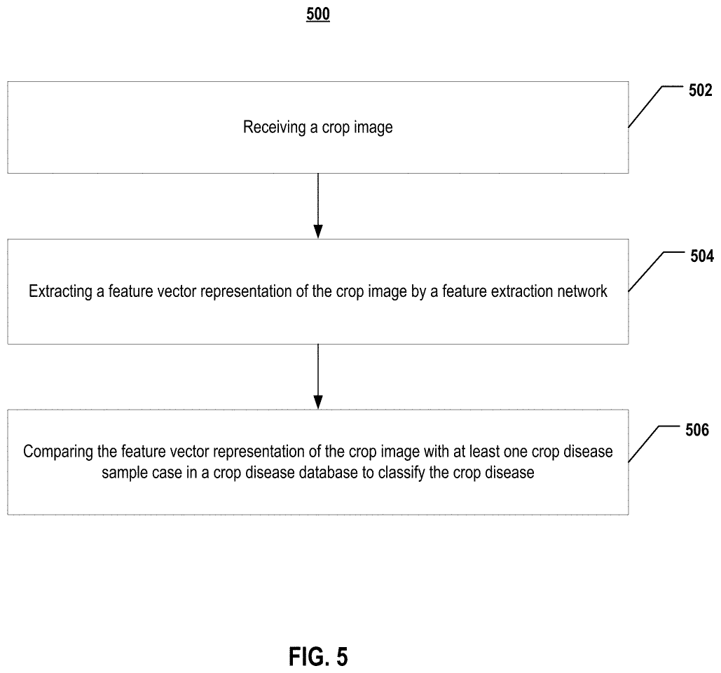

FIG. 5 is a flowchart of a method 500 for diagnosing a crop disease, according to embodiments of the disclosure. In operation 502, a crop image is received. In some embodiments, the user may use a user terminal, e.g., a cellphone, to obtain the crop image, which is subsequently received by a crop disease diagnosis system through a communication interface. Then, in operation 504, a feature vector representation of the crop image is extracted by a feature extraction network.

In some embodiments, the feature extraction network may be built in advance by using a plurality of sample crop images. Each sample crop image may represent one crop disease. The spatial information of the plurality of sample crop images may be first obtained, and the spatial information of each sample crop image is then converted into an original feature extraction network by using a fully connected layer. The original feature extraction network of each sample crop image may at least include a crop type and a crop disease type. After building the original feature extraction network based on the plurality of sample crop images, the fully connected layer is removed from the original feature extraction network, and then a simplified and lightweight model, the feature extraction network, is obtained. After removing the fully connected layer, the feature extraction network could deploy the plurality of sample crop images as the feature vector representations, and the feature vector representation of each sample crop image may be annotated by a sample crop disease and/or a sample crop type. In some embodiments, the feature vector representations of the sample crop images may be stored in a crop disease database.

In operation 504, the feature vector representation of the crop image obtained in operation 502 may be extracted by using the feature extraction network. Then, in operation 506, the extracted feature vector representation of the crop image may be compared with the feature vector representations of the sample crop images stored in the crop disease database. In some embodiments, the extracted feature vector representation of the crop image may be compared with the feature vector representations of the sample crop images stored in the crop disease database by using a nearest neighbor algorithm to obtain a similarity degree. The crop disease having a highest similarity degree may be provided as the classification result. Then, the crop disease and/or the crop type of the crop image can be classified.

In some embodiments, while converting the spatial information of each sample crop image into the original feature extraction network, each sample crop image may be analyzed with a convolutional neural network (CNN) to obtain the spatial information of each sample crop image, and then the spatial information of each sample crop image may be converted into the original feature extraction network by the fully connected layer.

In some embodiments, after operation 506 that compares the extracted feature vector representation of the crop image with the feature vector representations of the sample crop images stored in the crop disease database, the feature vector representation of the crop image may not match any of the crop disease sample cases in the crop disease database. Under this situation, the present disclosure further provides an expansion flexibility to the crop disease database.

The crop disease database may be updated by applying a clustering algorithm to the feature vector representation of the crop image when the feature vector representation of the crop image does not match any of the at least one crop disease sample case in the crop disease database. The cluster analysis is performed on the feature vector representation of the crop image to find one crop disease sample case that is nearest to the feature vector representation of the crop image. Then, an exemplary sample case corresponding to the feature vector representation of the crop image would be added to the crop disease database, and the exemplary sample case may indicate a crop disease and/or a crop type that is nearest to the feature vector representation of the crop image.

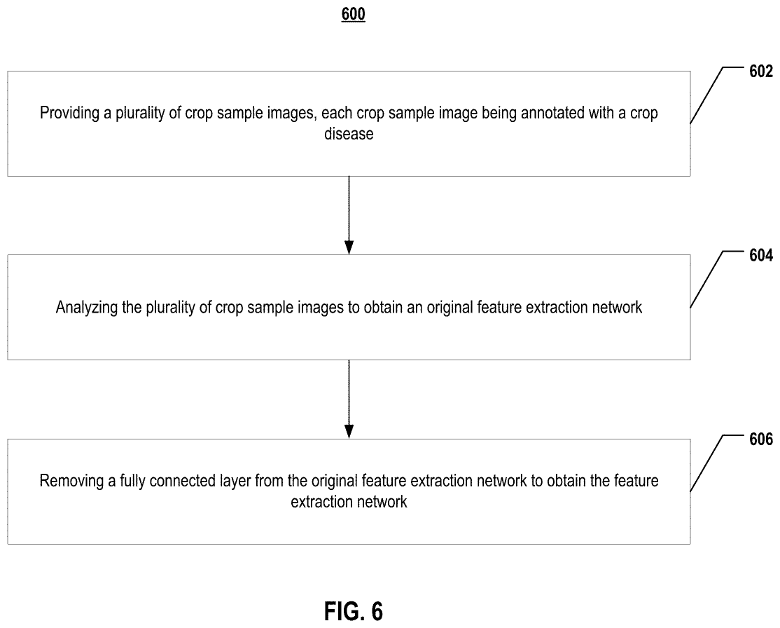

FIG. 6 is a flowchart of a method 600 for building a feature extraction network of a crop disease diagnosis system, according to embodiments of the disclosure. In operation 602, a plurality of sample crop images are provided, and each sample crop image is annotated with a sample crop disease in advance. In some embodiments, the sample crop images may be provided and annotated by the user using a user terminal, e.g., cellphone. In some embodiments, the sample crop images may be provided and annotated when building a crop disease database.

In operation 604, the plurality of sample crop images are analyzed to obtain an original feature extraction network. In some embodiments, each sample crop image is analyzed with a convolutional neural network (CNN) to obtain spatial information of each sample crop image. Then, the spatial information of each sample crop image may be converted into the original feature extraction network by the fully connected layer, and a feature vector representation of each sample crop image is obtained.

In operation 606, after obtaining the original feature extraction network by the fully connected layer, the fully connected layer is removed from the original feature extraction network to obtain the feature extraction network. After removing the fully connected layer, the feature extraction network could deploy the plurality of sample crop images as the feature vector representations, and the feature vector representation of each sample crop image may be annotated by a sample crop disease and/or a sample crop type. In some embodiments, the feature vector representations of the sample crop images may be stored in a crop disease database. Because the feature extraction network is a lightweight model with the removal of the fully connected layer, the process time would be shortened, and the process loading would be reduced.

In some embodiments, after building the feature extraction network by using method 600, method 500 for diagnosing a crop disease may use this feature extraction network to perform diagnosis operations to classify the crop disease. For example, a new crop image may be obtained by the user using the user terminal and the feature vector representation of the new crop image may be extracted. The feature vector representation of the new crop image may be compared with the feature vector representations in the crop disease database built by method 600.

Furthermore, in some embodiments, when the feature vector representation of the new crop image does not match any of the feature vector representations in the crop disease database, method 600 may further updating the crop disease database. For example, when the feature vector representation of the new crop image does not match any of the feature vector representations in the crop disease database, a cluster analysis may be performed to find a crop disease sample case in the crop disease database that is nearest to the feature vector representation of the new crop image. Then, an exemplary sample case corresponding to the feature vector representation of the new crop image would be added to the crop disease database, and the exemplary sample case may indicate a crop disease and/or a crop type that is nearest to the feature vector representation of the crop image.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

According to one aspect of the present disclosure, a crop disease diagnosis system is disclosed. The crop disease diagnosis system includes a communication module, a crop disease database, and a crop feature classification module. The communication module is configured to receive a crop image. The crop disease database stores at least one crop disease sample case. The crop feature classification module is configured to extract a feature vector representation of the crop image, compare the feature vector representation of the crop image with the at least one crop disease sample case, and classify a crop disease associated with the crop image. The feature vector representation of the crop image is extracted by a feature extraction network, and a fully connected layer is removed from the feature extraction network during classification of the crop disease.

In some embodiments, the crop disease diagnosis system further includes a user terminal. The communication module receives the crop image from the user terminal and transmits a classification result of the crop disease to the user terminal. In some embodiments, the crop feature classification module is further configured to classify a crop type associated with the crop image.

In some embodiments, the crop disease diagnosis system further includes a training module. The training module uses the fully connected layer to extract feature vector representations of a plurality of sample crop images associated with the at least one crop disease sample case, and annotates each sample crop image with a sample crop disease based on the feature vector representations. In some embodiments, the feature vector representations of the plurality of sample crop images indicate at least one of a crop type and a disease type associated with each sample crop image. In some embodiments, the feature vector representations of the plurality of sample crop images are obtained by converting spatial information of each sample crop image into an original feature extraction network. In some embodiments, the feature extraction network is obtained by removing the fully connected layer from the original feature extraction network.

In some embodiments, the crop feature classification module is further configured to update the crop disease database by applying a clustering algorithm to the feature vector representation of the crop image when the feature vector representation of the crop image does not match any of the at least one crop disease sample case in the crop disease database. In some embodiments, when the feature vector representation of the crop image does not match any of the at least one crop disease sample case in the crop disease database, the crop feature classification module is further configured to perform a cluster analysis to find one crop disease sample case that is nearest to the feature vector representation of the crop image.

In some embodiments, the crop feature classification module is further configured to compare the feature vector representation of the crop image with the at least one crop disease sample case by using a nearest neighbor algorithm to obtain a similarity degree. In some embodiments, the crop disease having a highest similarity degree is provided to the communication module as the classification result.

According to another aspect of the present disclosure, a method for diagnosing a crop disease is disclosed. A crop image is received. A feature vector representation of the crop image is extracted by a feature extraction network. The feature vector representation of the crop image is compared with at least one crop disease sample case in a crop disease database to classify the crop disease. A fully connected layer is removed from the feature extraction network during classification of the crop disease.

In some embodiments, the crop image is obtained through a user terminal, and a classification result of the crop disease is transmitted to the user terminal. In some embodiments, feature vector representations of a plurality of sample crop images associated with the at least one crop disease sample case are extracted by using the fully connected layer. Each sample crop image is annotated with a sample crop disease based on the feature vector representations to build the crop disease database. In some embodiments, at least one of a crop type and a disease type associated with each sample crop image is indicated.

In some embodiments, spatial information of each sample crop image is converted into an original feature extraction network, and the fully connected layer is removed from the original feature extraction network. In some embodiments, each sample crop image is analyzed with a convolutional neural network (CNN) to obtain the spatial information of each sample crop image. The spatial information of each sample crop image is converted into the original feature extraction network by the fully connected layer.

In some embodiments, the crop disease database is updated by applying a clustering algorithm to the feature vector representation of the crop image when the feature vector representation of the crop image does not match any of the at least one crop disease sample case in the crop disease database. In some embodiments, a cluster analysis is performed to find one crop disease sample case that is nearest to the feature vector representation of the crop image when the feature vector representation of the crop image does not match any of the at least one crop disease sample case in the crop disease database.

In some embodiments, the feature vector representation of the crop image is compared with the at least one crop disease sample case by using a nearest neighbor algorithm to obtain a similarity degree. In some embodiments, the crop disease having a highest similarity degree is provided as the classification result.

According to another aspect of the present disclosure, a method for building a feature extraction network of a crop disease diagnosis system is disclosed. A plurality of sample crop images are provided, and each sample crop image is annotated with a sample crop disease. The plurality of sample crop images are analyzed to obtain an original feature extraction network. A fully connected layer is removed from the original feature extraction network to obtain the feature extraction network.

In some embodiments, a feature vector representation of each sample crop image is obtained. In some embodiments, each sample crop image is analyzed with a convolutional neural network (CNN) to obtain spatial information of each sample crop image. The spatial information of each sample crop image is converted into the original feature extraction network by the fully connected layer.

In some embodiments, the feature vector representations of the plurality of sample crop images are stored in a crop disease database. A new crop image is obtained, and the feature vector representation of the new crop image is extracted. The feature vector representation of the new crop image is compared with the feature vector representations in the crop disease database. The crop disease database is updated when the feature vector representation of the new crop image does not match any of the feature vector representations in the crop disease database.

In some embodiments, when the feature vector representation of the new crop image does not match any of the feature vector representations in the crop disease database, a cluster analysis is performed to find a crop disease sample case in the crop disease database that is nearest to the feature vector representation of the new crop image.

According to a further aspect of the present disclosure, a non-transitory computer-readable medium is disclosed. The non-transitory computer-readable medium has instructions stored thereon. When the instructions are executed by at least one processor, the at least one processor is caused to perform a method for diagnosing a crop disease. The method for diagnosing a crop disease includes receiving a crop image, extracting a feature vector representation of the crop image by a feature extraction network, and comparing the feature vector representation of the crop image with at least one crop disease sample case in a crop disease database to classify the crop disease. A fully connected layer is removed from the feature extraction network during classification of the crop disease.

The foregoing description of the specific implementations can be readily modified and/or adapted for various applications. Therefore, such adaptations and modifications are intended to be within the meaning and range of equivalents of the disclosed implementations, based on the teaching and guidance presented herein. The breadth and scope of the present disclosure should not be limited by any of the above-described exemplary implementations, but should be defined only in accordance with the following claims and their equivalents.

What is claimed is:

1. A crop disease diagnosis system, comprising:
a communication module configured to receive a crop image;
a crop disease database storing at least one crop disease sample case; and
a crop feature classification module configured to extract a feature vector representation of the crop image, compare the feature vector representation of the crop image with the at least one crop disease sample case, and classify a crop disease associated with the crop image,
wherein the feature vector representation of the crop image is extracted by a feature extraction network, and
wherein a fully connected layer is removed from the feature extraction network during classification of the crop disease.

2. The crop disease diagnosis system of claim 1, further comprising a user terminal,
wherein the communication module receives the crop image from the user terminal and transmits a classification result of the crop disease to the user terminal.

3. The crop disease diagnosis system of claim 1, wherein the crop feature classification module is further configured to classify a crop type associated with the crop image.

4. The crop disease diagnosis system of claim 1, further comprising a training module,
wherein the training module uses the fully connected layer to extract feature vector representations of a plurality of sample crop images associated with the at least one crop disease sample case, and annotates each sample crop image with a sample crop disease based on the feature vector representations.

5. The crop disease diagnosis system of claim 4, wherein the feature vector representations of the plurality of sample crop images indicate at least one of a crop type and a disease type associated with each sample crop image.

6. The crop disease diagnosis system of claim 4, wherein the feature vector representations of the plurality of sample crop images are obtained by converting spatial information of each sample crop image into an original feature extraction network.

7. The crop disease diagnosis system of claim 6, wherein the feature extraction network is obtained by removing the fully connected layer from the original feature extraction network.

8. The crop disease diagnosis system of claim 1, wherein the crop feature classification module is further configured to update the crop disease database by applying a clustering algorithm to the feature vector representation of the crop image when the feature vector representation of the crop image does not match any of the at least one crop disease sample case in the crop disease database.

9. The crop disease diagnosis system of claim 8, wherein, when the feature vector representation of the crop image does not match any of the at least one crop disease sample case in the crop disease database, the crop feature classification module is further configured to perform a cluster analysis to find one crop disease sample case that is nearest to the feature vector representation of the crop image.

10. The crop disease diagnosis system of claim 1, wherein the crop feature classification module is further configured to compare the feature vector representation of the crop image with the at least one crop disease sample case by using a nearest neighbor algorithm to obtain a similarity degree.

11. The crop disease diagnosis system of claim 10, wherein the crop disease having a highest similarity degree is provided to the communication module as the classification result.

12. A method for diagnosing a crop disease, comprising:
receiving a crop image;
extracting a feature vector representation of the crop image by a feature extraction network; and
comparing the feature vector representation of the crop image with at least one crop disease sample case in a crop disease database to classify the crop disease,
wherein a fully connected layer is removed from the feature extraction network during classification of the crop disease.

13. The method of claim 12, further comprising:
obtaining the crop image through a user terminal; and
transmitting a classification result of the crop disease to the user terminal.

14. The method of claim 12, further comprising:
extracting feature vector representations of a plurality of sample crop images associated with the at least one crop disease sample case using the fully connected layer; and
annotating each sample crop image with a sample crop disease based on the feature vector representations to build the crop disease database.

15. The method of claim 14, wherein annotating each sample crop image with the sample crop disease based on the feature vector representations, comprises:
indicating at least one of a crop type and a disease type associated with each sample crop image.

16. The method of claim 14, further comprising:
converting spatial information of each sample crop image into an original feature extraction network; and
removing the fully connected layer from the original feature extraction network.

17. The method of claim 16, wherein converting spatial information of each sample crop image into the original feature extraction network, comprises:
analyzing each sample crop image with a convolutional neural network (CNN) to obtain the spatial information of each sample crop image; and
converting the spatial information of each sample crop image into the original feature extraction network by the fully connected layer.

18. The method of claim 14, further comprising:
updating the crop disease database by applying a clustering algorithm to the feature vector representation of the crop image when the feature vector representation of the crop image does not match any of the at least one crop disease sample case in the crop disease database.

19. The method of claim 12, wherein comparing the feature vector representation of the crop image with at least one crop disease sample case in a crop disease database to classify the crop disease, comprises:
comparing the feature vector representation of the crop image with the at least one crop disease sample case by using a nearest neighbor algorithm to obtain a similarity degree.

20. A non-transitory computer-readable medium having instructions stored thereon that, when executed by at least one processor, causes the at least one processor to perform a method for diagnosing a crop disease, comprising:
receiving a crop image;
extracting a feature vector representation of the crop image by a feature extraction network; and
comparing the feature vector representation of the crop image with at least one crop disease sample case in a crop disease database to classify the crop disease,
wherein a fully connected layer is removed from the feature extraction network during classification of the crop disease.
